(19) United States
(12) Patent Application Publication
(10) Pub. No.: US 2004/0195741 A1
(43) Pub. Date: Oct. 7, 2004

(54) Force protector for pallet rack systems

(76) Inventor: Loran Michael Jones, Rydal, GA (US)

Correspondence Address: Douglas M. Clarkson, 240 Marietta Hwy., Canton, GA, 30114, US

(21) Appl. No.: 10/725,656

(22) Filed: Nov. 24, 2003

Related U.S. Application Data
(60) Provisional application No. 60/428,927, filed on Feb. 4, 2003.

(51) Int. Cl. F16M 11/00

(52) U.S. Cl. 267/136

(57) ABSTRACT

The force protector for a structure has a plurality of surfaces adjacent a structure to be protected from an external force encountering the structure. At least one of said surfaces has spring means positioned intermediate said one surface and said structure. Two of said plurality of surfaces arranged sloping from opposite ends of said one surface in order to deflect at least partially such an external force, and these springs will absorb at least partially said force. It is this combination of the sloping surfaces and the resilient means that provide a maximum protection.

### REFERENCE

The information, data and all benefits of provisional application No. 60/428,927 filed Feb. 4, 2003 are incorporated by reference into this description.

The writing, the subject matter, and the description presented herein is protected under the provisions of United States Copyright laws, except only to any extent required by law in order to obtain and to continue all patent protection that is available during the term of any patent that issues hereon.

### BACKGROUND OF THE INVENTION

1. Field of the Invention

The present invention, generally, relates to warehouse storage arrangements and systems for pallet racks of multiple heights and depths accessible by forklift trucks and, more particularly, to a protector for such pallet racks from the force of an impact by the forklift trucks.

2. Background of the Invention Field

The advances in warehouse storage systems in today's markets is remarkable. These advances are from a simple back room where boxes of supplies were stacked—to today's hugh warehouses with multiple sections of racks extending across an allotted space in a warehouse to support pallets two and three deep.

A section in a pallet rack storage system includes vertical columns to support rails on which carts carry pallets that can be retrieved, one by one, from an aisle by, for example, a forklift. Much attention has been devoted in developing very clever “push-back” cart storage systems, many are in use today, and many are damaged by forklifts.

In the past when it became evident that the upright members of these cart storage systems were being damaged by the forklifts, studies revealed that it was not caused by careless operators of the forklifts, but rather, operating care, it seemed, did not avoid an occasional encounter with these upright members.

Damaged file systems caused costly delays in obtaining access to parts, material and whatever was stored. These costs have lead to some very clever force absorbing arrangements proposed to overcome the devastating results, or to avoid the damage altogether.

### OBJECTS AND SUMMARY OF THE INVENTION

It is an object of the present invention to provide a force-absorbing device, that current plans include test marketing under the trademark, “Loran Device”, that are being tested and already have proved to work well.

Another object of the present invention is to provide a device for attaching to the upright legs of storage racks that are usually accessed by forklift trucks to prevent damage to the racks when encountered by a forklift truck.

Briefly, a device that is constructed and arranged according to the present invention includes at least two surfaces to fit adjacent an upright part of a structure to be protected from an external force encountering the structure. The device includes a fixed surface located a distance from the upright leg and includes resilient means supported intermediate said structure and said surfaces. The external force that is directed at said upright part is at partially intercepted by said surfaces and at least partially absorbed by said resilient means.

The above and other objects and advantages of the present invention will become more readily apparent from a more detailed description to follow taken in conjunction with the drawings.

### BRIEF DESCRIPTION OF THE DRAWINGS

FIG. 1 is a top view of the device of the present invention as an aid in describing the details of its construction and operation.

FIG. 2 is a rear view of the device constructed in accordance with the present invention as a further aid in its description.

FIG. 3 is an illustration indicating how the device of the invention is located on a leg of a storage rack.

FIG. 4 is an illustration of a multi-level storage rack as an aid in describing one use of the device of the present invention.

### DETAILED DESCRIPTION OF THE INVENTION

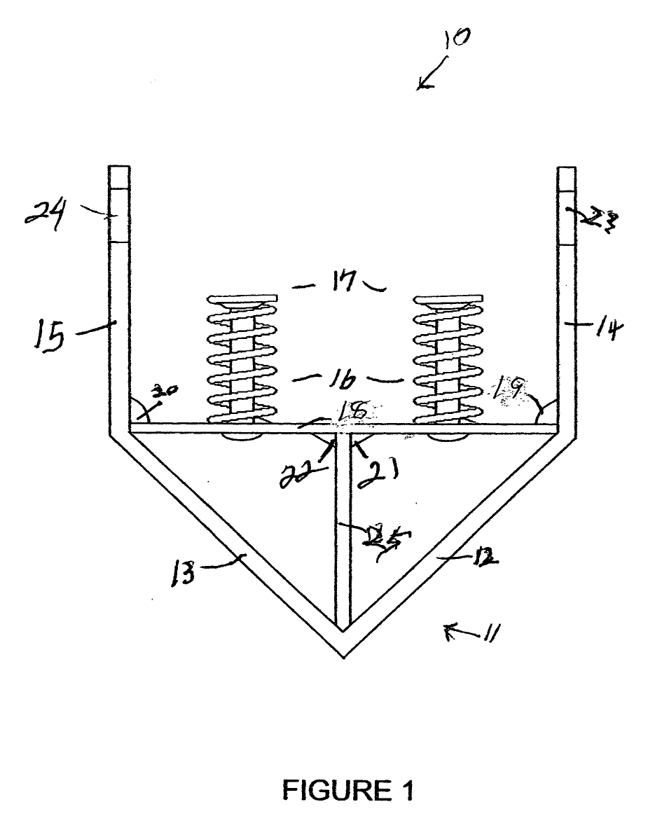

Referring first to FIG. 1 of the drawings, the view of the protector device 10 is looking down from above. The device is a protector that will protect any structure but, for the purposes of describing its arrangement and function, will be described as being for protecting the upright support leg of a storage rack that faces the traffic of forklift trucks in the isles to access the racks.

An outer surface 11 is formed in a generally “V” shape, as indicated at 12 and 13, with opposite sides 14 and 15 forming a space to fit around the structure to be protected. A plurality of resilient springs 16, with ends 17, are located to fit intermediate an upright portion of the structure to be protected and a panel 18 that is welded, as indicated by the reference numbers 19 and 20.

The panel 18 is fitted against a panel 25 approximately midway between the springs 16. The panel 18 and the panel 25 are welded at 21 and 22 to produce a maximum support for the springs 16. The ends 17 of the springs 16 fit against the upright portion of the structure to be protected.

The generally “V” configuration, or arrangement, of the outer surface 11 will deflect a blow from, for example, a forklift truck that would hit the pallet rack upright support leg. While the material from which the device is constructed can vary depending upon the size of the force expected, to protect an upright support leg of a storage rack, 3/16 inch sheet metal that is 48 inches wide and 96 inches long has been found entirely satisfactory.

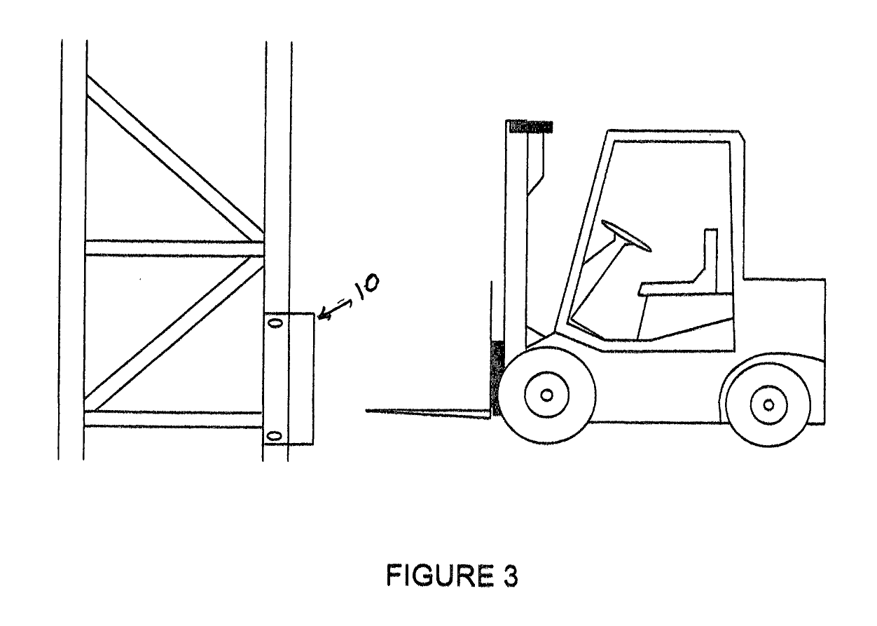

After the side panels are formed, the elongated openings indicated by the reference numbers 23 and 24 are formed in the side panels 14 and 15 for attaching the device to the upright support leg in a desired location. The configuration of these openings 23 and 24, better seen in FIG. 3, provides a safety feature for the device 10 of the present invention.

When the springs are nearly compressed completely, having about 3/16 inch remaining, the elongated configuration of these slots permits an additional safety feature. While a forklift traveling at 4 mph hit the protector 10 during a test, no damage was evidenced to a frame being tested.

There are conditions that could possibly affect the characteristics of the springs, and they will be described in more detail in hereafter. An example would be when a forklift truck to be used is bigger and more powerful, perhaps with an inexperienced driver, it could be expected that an impact will be more forceful, and a heavier spring will be selected.

However, more frequently the forklift drivers are experienced and careful in their operation in pallet rack areas. Therefore, by far a spring of customary stiffness is entirely effective, and tests that have been made with the protector device in place and an inexperienced fork lift driver maneuvering between racks failed to produce serious damage.

The springs must be of sufficient resilience to, at least partially, absorb such a force expected to be encountered. Each spring, therefore, is formed from 3/16 inch bar stock material.

The sloping surfaces 12 and 13 will partially deflect such a force, and these springs will absorb any remaining force. It is this combination of the resilient means and the sloping surfaces that provide a maximum protection.

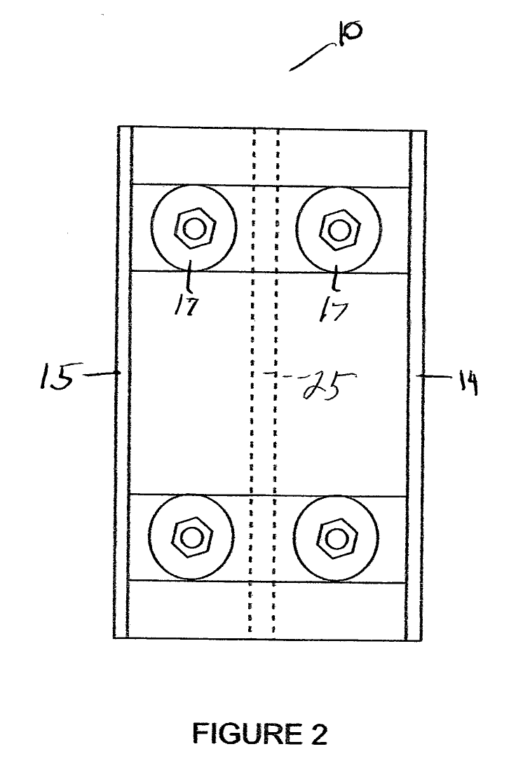

FIG. 2 of the drawings shows the rear of the protector device with four springs to absorb a blow. The ends 17 of the springs facing the viewer are located against a structure to be protected and the opposite ends against a panel 18 welded to the outer surface, as described hereinabove.

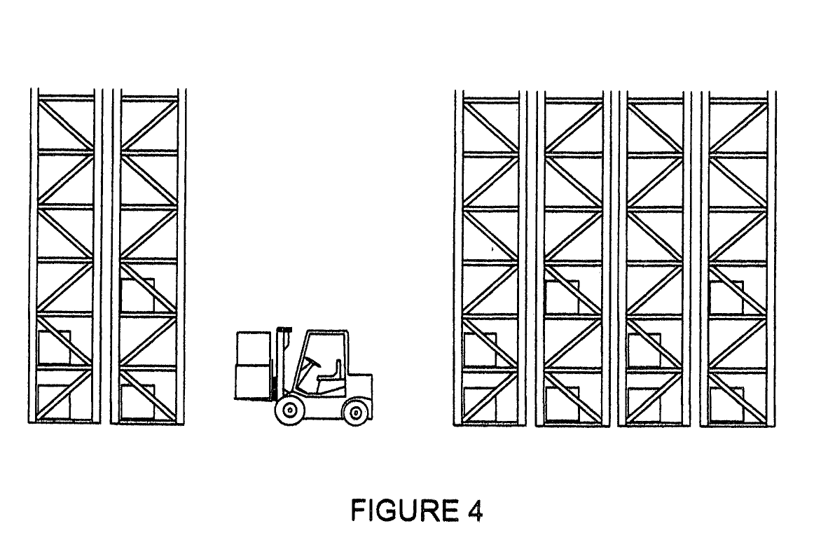

FIG. 3 and FIG. 4 are included only to illustrate the environment in which the force protector of the present invention is anticipated to be particularly useful. Each of these views do not require a detailed description in that they are clear as shown.

The invention has been shown, described and illustrated in substantial detail with reference to presently preferred forms of the invention. It will be understood by those skilled in this art that various changes and modifications may be made without departing from the spirit and scope of the invention which is defined by the appended claims.

What is claimed is:

1. A device to absorb a force directed at an upright leg of a storage rack, comprising:
a plurality of surfaces supported adjacent said upright leg;
a fixed surface located a predetermined from said upright leg;
resilient means movably supported intermediate said plurality of surfaces; and
said fixed surface to permit said plurality of surfaces limited movement toward and away from said upright leg;
whereby a force that is directed at said upright part is at least partially intercepted by said surfaces and at least partially absorbed by said resilient means.

2. A device to absorb a force directed at an upright part of a structure, comprising:
a plurality of surfaces supported adjacent said upright part;
a fixed surface located a predetermined distance from said upright part; and
resilient means supported intermediate said plurality of surfaces and said fixed surface to permit said plurality of surfaces movement relative to said upright part;
whereby a force that is directed at said upright part is at partially intercepted by said surfaces and at least partially absorbed by said resilient means.

3. A device to absorb a force directed at an upright part of a structure as described by claim 1 wherein said upright part is an upright support leg of a storage rack.

4. A device to absorb a force directed at an upright part of a structure as described by claim 2 wherein said plurality of surfaces includes two, one located on each side of said upright part.

5. A device to absorb a force directed at an upright part of a structure as described by claim 2 wherein said resilient means includes at least two coil springs.

6. A device to absorb a force directed at an upright part of a structure as described by claim 2 wherein said plurality of surfaces each includes openings for attaching said device to said upright part.

7. A force protector device to at least partially deflect and at least partially absorb a force directed at an upright support leg of a warehouse pallet rack structure, comprising:
two surfaces located in a spaced apart position to fit adjacent said upright leg, one surface on each side;
a fixed surface located a predetermined distance from said upright leg welded at opposite ends to each of said two surfaces; and
resilient spring means supported intermediate said fixed surface and said upright support leg to permit said of movement of said protector device relative to said upright leg to absorb at least part of said force;
whereby a force that is directed at said upright part is intercepted by said surfaces and at least partially absorbed by said resilient means.

8. A force protector device to at least partially deflect and at least partially absorb a force directed at an upright support leg of a warehouse pallet rack structure as described by claim 7 wherein said surface on each side of said upright support leg includes an opening for attaching said device to a pallet rack structure.

9. A force protector device to at least partially deflect and at least partially absorb a force directed at an upright support leg of a warehouse pallet rack structure as described by claim 7 wherein said surface on each side of said support leg has a bend toward each other terminating together a predetermined distance from said fixed surface.

10. A force protector device to at least partially deflect and at least partially absorb a force directed at an upright support leg of a warehouse pallet rack structure as described by claim 9 wherein said bend that terminates together includes a panel fitted within said predetermined distance.

11. A force protector device to at least partially deflect and at least partially absorb a force directed at an upright support leg of a warehouse pallet rack structure as described by claim 7 wherein said surface on each side of said upright support leg includes an opening for attaching said device to a pallet rack structure; said surface on each side has a bend toward each other terminating together; and a panel fitted between the bend together of said two surfaces and said fixed surface.
